(19) United States
(12) Patent Application Publication
(10) Pub. No.: US 2006/0279805 A1
(43) Pub. Date: Dec. 14, 2006

(54) Image reading apparatus

(75) Inventor: Kyoo-sang Jo, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/451,296

(22) Filed: Jun. 13, 2006

(30) Foreign Application Priority Data
Jun. 14, 2005 (KR) 2005-51129

(51) Int. Cl. H04N 1/04

(52) U.S. Cl. 358/474; 358/486

(57) ABSTRACT

An image reading apparatus includes a scanning module reading an image of a document while sliding, a guide module guiding the scanning module to slide along an axis, and a drive module including first and second timing belts respectively coupled to both ends of the scanning module, first and second belt pulleys having teeth for respectively circulating the first and second timing belts, a connection shaft coaxially connecting the first and second belt pulleys, a drive motor, and a gear train, as a driving force transfer member, directly connecting the drive motor and the first belt pulley.

### CROSS-REFERENCE TO RELATED PATENT APPLICATION

This application claims the benefit of Korean Patent Application No. 2005-51129, filed on Jun. 14, 2005 in the Korean Intellectual Property Office, the disclosure of which is incorporated herein in its entirety by reference.

### BACKGROUND OF THE INVENTION

1. Field of the Invention

Aspects of the present invention relate to an image reading apparatus, and more particularly, to an image reading apparatus for reading an image while a scanning module slides.

2. Description of the Related Art

An image reading apparatus includes a scanning module for reading an image printed on a document by scanning light onto the document and converting an optical signal into an electric signal. The image reading apparatus may be, for example, scanners, facsimiles, and multi-functional printers.

To read the document, either the scanning module or the document needs to be moved. An image reading apparatus in which the scanning module is moved is referred to as a flat-bed type image reading apparatus. An image reading apparatus in which the document is moved is referred to as a sheet-feed type image reading apparatus. In addition, there is a hybrid type image reading apparatus in which an auto document feeder (ADF) is provided in the flat-bed type image reading apparatus.

FIG. 1 illustrates major parts of a conventional flat-bed type image reading apparatus. Referring to FIG. 1, the conventional flat-bed type image reading apparatus includes a flat glass 20 on which a document (not shown) is placed. A scanning module includes an optical scanning unit 21 for scanning light onto the document. An image sensor 44 converts an optical signal obtained by reading the document into an electric signal. A light reflection unit 22 for reflects light reflected by the document toward the image sensor 44. The image sensor 44 may be, for example, a charge-coupled device (CCD) sensor.

The optical scanning unit 21 is provided under a lower surface of the flat glass 20 and includes an optical source 40 and a first reflective mirror 41. The optical scanning unit 21 is coupled to a wire 28 and is moved at a velocity V while scanning light onto the document placed on the flat glass 20. The light reflection unit 22 is located close to the optical scanning unit 21 and includes a second reflective mirror 42 and a third reflective mirror 43. The optical scanning unit 22 includes a pulley 24 around which the wire 28 is wound and is moved at a velocity V/2 while reflecting the light scanned by the optical scanning unit 21 toward the image sensor 44 using mirrors 42, 43. The image sensor 44 converts the optical signal reflected by the light reflection unit 22 into an electric signal and transmits the electric signal to an image processor (not shown) of the image reading apparatus.

Both ends of the wire 28 are fixedly connected to corresponding fixing points 23 and 31. The wire 28, while having one fixed to the fixing point 23 and the other end fixed to the fixing point 31, is sequentially wound around the pulley 24 provided in the light reflection unit 22, around pulleys 25, 26, and 27 fixed to a main body (not shown) of the image reading apparatus, coupled to the optical scanning unit 21, and wound around the pulley 24 again. When a drive pulley 26 moves the wire 28 at the velocity V, the optical scanning unit 21 is moved at the same velocity V while the light reflection unit 22 is moved at the velocity V/2. Thus, as indicated by a dotted line in FIG. 1, the overall length of an optical path from the optical source 40 to the image sensor 44 is maintained constant.

In order to slide the optical scanning unit 21, the light reflection unit 22, and the image sensor 44, together, the size and weight of the scanning module need to be increased. When the size and weight of the scanning module increase, the position or velocity of the scanning module that slides is difficult to control and a sliding mechanism becomes complicated. In an image reading apparatus employing a CCD sensor as the image sensor 44, the CCD sensor is fixed to the main body of the image reading apparatus as a separate part and normally does not slide.

In particular, to maintain a constant scanning time per page regardless of the size of a document, the scanning module whose volume and weight is increased according to the size of the document needs to slide at a higher velocity. Furthermore, as the scanning quality of the image reading apparatus is improved, the resolution of the scanning module tends to increase. The CCD sensor has a relatively higher resolution. Accordingly, in the image reading apparatus capable of reading an A3 size document, the CCD sensor is mostly fixed to the main body of the image reading apparatus. Also, the cost of such an image reading apparatus increases due to the increased resolution and complexity of the sliding mechanism.

When the image sensor 44 does not slide and is fixed to the main body of the image reading apparatus, many of parts such as the wire 28 and the pulley 24 need to be installed in a complicated structure to maintain the overall length of the optical path constant. However, misreading may occur due to a slip between the wire 28 and the pulleys 24, 25, 26, and 27. When the drive pulley 26 and a drive motor 29 for driving the wire 28 are not directly engaged by means of gears but connected by means of a belt 30 or a frictional wheel, the transfer of power may be inaccurate and misreading may occur.

### SUMMARY OF THE INVENTION

Aspects of the present invention provide an image reading apparatus having a simplified structure in which an image sensor and a scanning module slide together and which is capable of accurately performing a reading operation even when the size of a document is large.

According to an aspect of the present invention, an image reading apparatus comprises a scanning module reading an image of a document while sliding, a guide module guiding the scanning module to slide along an axis, and a drive module including first and second timing belts respectively coupled to both ends of the scanning module, first and second belt pulleys having teeth for respectively circulating the first and second timing belts, a connection shaft coaxially connecting the first and second belt pulleys, a drive motor, and a gear train, as a driving force transfer member, directly connecting the drive motor and the first belt pulley.

According to an aspect of the present invention, the scanning module includes one of a contact image sensor (CIS) or a charge-coupled device (CCD) sensor and slides therewith.

According to an aspect of the present invention, the document has a maximum A3 size.

According to an aspect of the present invention, the drive module further comprises a first bracket coupling the first belt pulley, the drive motor, and the gear train to a main body of the image reading apparatus, and a second bracket coupling the second belt pulley to the main body of the image reading apparatus.

According to an aspect of the present invention, the first and second brackets respectively comprise a stud inserted into the centers of the first and second belt pulleys and rotatably supporting the first and second belt pulleys.

According to an aspect of the present invention, the guide module comprises a guide shaft inserted into a guide hole that is formed in the scanning module.

According to an aspect of the present invention, a single guide shaft is provided at a position more adjacent to the first timing belt than the second timing belt.

### BRIEF DESCRIPTION OF THE DRAWINGS

The above and other features and/or advantages of the present invention will become more apparent and more readily appreciated by describing in detail embodiments thereof with reference to the accompanying drawings in which:

FIG. 1 is a side view illustrating major parts of a conventional flat-bed type image reading apparatus;

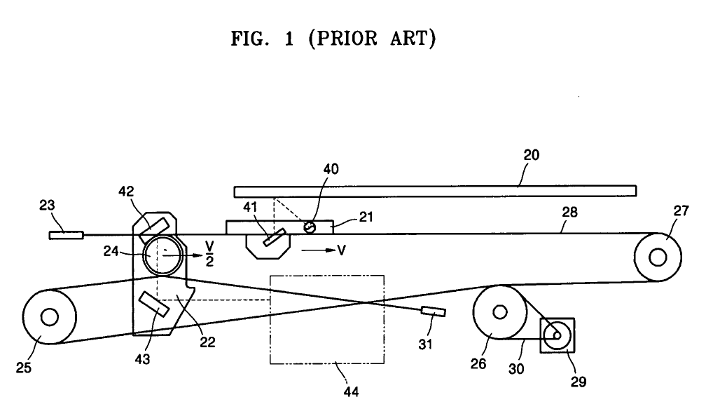

FIG. 2 is a perspective view illustrating major parts of an image reading apparatus according to an embodiment of the present invention;

FIG. 3 is a side view of a gear train 100 of FIG. 2; and

FIG. 4 is a cross-sectional view showing a state in which the first and second belt pulleys are coupled to each other.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

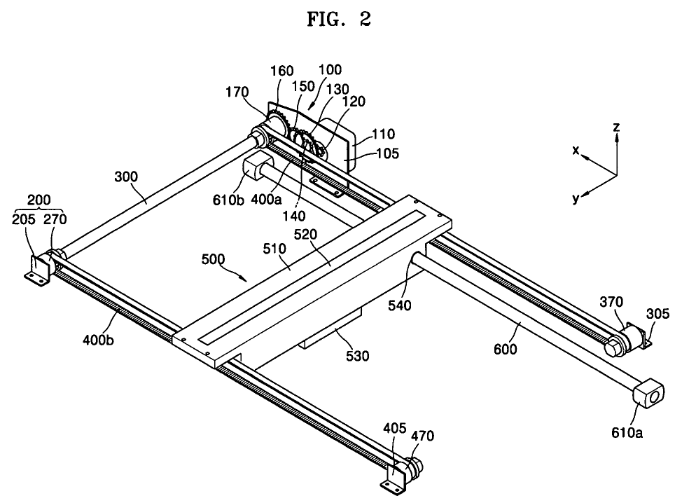

Referring to FIG. 2, in an image reading apparatus according to an embodiment of the present invention, a scanning module 500 reads an image of a document while sliding. A guide module guides the scanning module 500 to slide along an axis. A drive module allows the scanning module 500 to slide.

The scanning module 500 includes a lens portion 520, which scans (not shown) light onto a document and receives the light reflected by the document. The module 500 further includes a CCD (charge-coupled device) sensor 530 to convert the light received by the lens portion 520 into an electric signal, and a housing 510 in which the lens portion 520 and the CCD sensor 530 are coupled to each other. The CCD sensor 530 has a relatively larger depth of focus. In another embodiment, the scanning module 500 can include a contact image sensor (CIS) instead of the CCD sensor. When the CIS is used, the depth of focus decreases so that a gap between the document and the CIS must be maintained constant. However, it is understood that other sensors and sensor arrays can be used.

The guide module includes a guide hole 540 formed in the housing 510 and a guide shaft 600 inserted in the guide hole 540. The scanning module 500 slides in a direction x along the guide shaft 600 inserted in the guide hole 540. A vibration can be generated in the scanning module 500 that slides according to the amount of a gap between the guide hole 540 and the guide shaft 600, the number of the guide hole 540 and the guide shaft 600, and the surface roughness of the guide shaft 600. Since the vibration of the scanning module 500 causes an error in reading, the guide module is provided such that the amount of vibration is reduced.

According to an aspect of the invention, guide hole 540 may include a sliding bearing (not shown) for lubrication. In the present embodiment, only one guide shaft 600 is provided at a position more adjacent to a first timing belt 400a than a second timing belt 400b. The reason is because, if two guide shafts and two guide holes are provided to guide the movement of the scanning module, vibration generated from one of two coupling portions between the guide shafts and the guide holes acts on the remaining coupling portion as a momentum force. When the momentum force is excessive, the scanning module may zigzag in the x axis direction. Also, a torque ripple component exists in drive torque generated by a drive motor 110. The torque ripple component is more transferred to the first timing belt 400a that directly receives the drive torque. The torque ripple component generates a momentum force between the first timing belt 400a and the guide shaft 600. The momentum force decreases as the guide shaft 600 is provided closer to the first timing belt 400a. Thus, it is preferable (but not required) to provide a single guide shaft 600. The guide shaft 600 is preferably provided closer to the first timing belt 400a, but need not be in all aspects.

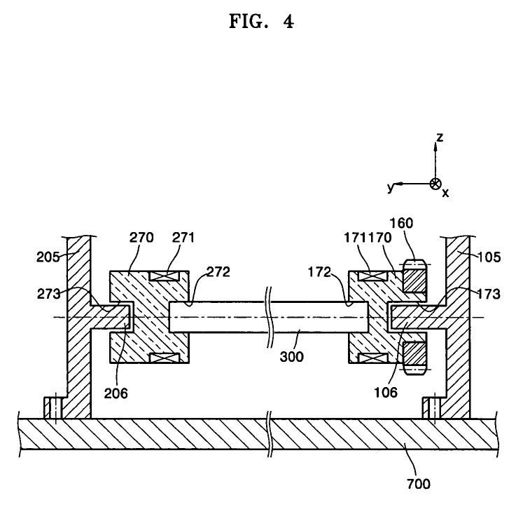

Shaft holders 610a and 610b affix corresponding ends of the guide shaft 600 to a main body 700 (shown in FIG. 4) of the image reading apparatus. The drive module includes first and second timing belts 400a and 400b coupled to both ends of the scanning module 500. The drive module further includes first and second belt pulleys 170 and 270 have teeth 171 and 271 (see FIG. 4) for respectively circulating the first and second timing belts 400a and 400b. A connection shaft 300 coaxially connects the first and second belt pulleys 170 and 270, the drive motor 110, and a gear train 100, as a driving force transfer member, directly connecting the drive motor 110 and the first belt pulley 170. However, it is other driving mechanisms can be used, that other pulley arrangements can be made, and that one or both of the belts 400a, 400b can be replaced with tracks, screws and other drive transmission mechanisms to push and/or pull the scanning module 500 relative to the document.

The teeth 171 and 271 are respectively formed on the first and second belt pulleys 170 and 270 which respectively circulate the first and second timing belts 400a and 400b. Accordingly, in spite of a sliding load of the scanning module 500, the slip between the first timing belt 400a and the first belt pulley 170, and the second timing belt 400b and the second belt pulley 270 are prevented. The drive module further includes a first bracket 105 coupling the first belt pulley 170, the drive motor 110, and the gear train 100 to the main body 700 of the image reading apparatus and a second bracket 205 coupling the second belt pulley 270 to the main body 700 of the image reading apparatus. While described as teeth, it is understood that other interlocking and/or male and female members can be used instead of or in addition to the teeth 171, 271.

The other end of the first timing belt 400a is coupled to a third belt pulley 370 while the other end of the second timing belt 400b is coupled to a fourth belt pulley 470. Teeth (not shown) are formed on the third and fourth belt pulleys 370 and 470. The third belt pulley 370 is coupled to the main body 700 of the image reading apparatus by a third bracket 305 while the fourth belt pulley 470 is coupled to the main body 700 of the image reading apparatus by a fourth bracket 405. Since the first and second belt pulleys 170 and 270 are coaxially connected by the connection shaft 300, both ends of the scanning module 500 slide at the same speed. While not required, it is understood that the third and fourth belt pulleys 370 and 470 can be coaxially connected in addition to or instead of first and second belt pulleys 170 and 270, and that the gear train 100 can be connected to additional pulleys in other aspects of the invention. Moreover, it is understood that a separate guide module need not be used in all aspects of the invention, such as where driving mechanism controls the orientation of the scanning module 500 while moving along the axis.

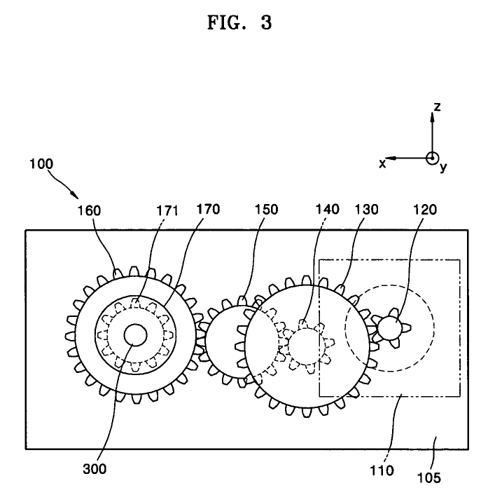

FIG. 3 illustrates the gear train 100 of FIG. 2. Referring to FIG. 3, the drive motor 110 for supplying a driving force to the first belt pulley 170 is fixed to the first bracket 105. The gear train 100 directly connects the drive motor 110 with the first belt pulley 170. In the shown embodiment, the gear train 100 includes a first gear 120 coaxially coupled to the drive motor 110. Second, third, fourth, and fifth gears 130, 140, 150, and 160 are sequentially connected to the first gear 120. The gear train 100 reduces the rotational speed of the drive motor 110 to transfer a driving force to the first belt pulley 170. However, it is understood that other types of gear trains can be used, and that other numbers and sizes of gears can be used to transmit rotations from the drive motor 110 to the pulleys 170, 270.

As the size of a document increases, the volume, weight, and sliding velocity of the scanning module 500 increase so that a probability of generation of an error in reading increases accordingly. In the shown embodiment of the present image reading apparatus, since the driving force is directly transferred to the scanning module 500 via the gear train 100, the first and second belt pulleys 170 and 270, the first and second timing belts 400a and 400b, and the connection shaft 300, a slip is not generated and the position and sliding velocity of the scanning module 500 can be accurately controlled. Thus, the scanning module 500 in the shown embodiment can read a document of an A3 size (297 mm×400 mm) without an error. However, it is understood that larger and smaller sizes can be read using the scanning module 500 in other aspects of the invention.

FIG. 4 illustrates a state in which the first and second belt pulleys 170 and 270 are coupled to each other. Referring to FIG. 4, the first bracket 105 includes a stud 106 inserted in the center of the first belt pulley 170 and rotatably supporting the first belt pulley 170. The second bracket 205 includes a stud 206 inserted in the center of the second belt pulley 270 and rotatably supporting the second belt pulley 270.

The first belt pulley 170 includes a stud insertion portion 173 into which the stud 106 of the first bracket 105 is inserted. The fifth gear 160 transmits the driving force from the drive motor 110 to the first belt pulley 170. The first belt pulley teeth 171 transmit the driving force to the first timing belt 400a. A connection shaft insertion portion 172 transmits the driving force to the pulley through a received end portion of the connection shaft 300 forcibly inserted. The second belt pulley 270 includes a stud insertion portion 273 into which the stud 206 of the second bracket 205 is inserted.

The second belt pulley 270 includes a second belt pulley teeth 271 to which the second timing belt 400b is connected, and a connection shaft insertion portion 272 into which the other end portion of the connection shaft 300 is forcibly inserted so as to receive the driving force. The first and second belt pulleys 170 and 270 are rotatably fixed to the main body 700 of the image reading apparatus respectively by the first and second brackets 105 and 205 having the studs 106 and 206. While shown using a plurality of belts and a guide shaft, it is understood that the driving force can be otherwise transmitted to the scanning module, such as through screw-type transmissions and/or hydraulics.

As described above, in the image reading apparatus according to aspects of the present invention, since the CCD sensor slides integrally with the scanning module, the structure of the image reading apparatus is simplified and the number of parts is reduced.

Since the driving force is directly transferred to both end portions of the scanning module via the timing belts, the belt pulleys, the connection shaft, and the gear train, the generation of a slip during sliding is prevented regardless of the size and weight of the scanning module. The position and sliding speed of the scanning module can be accurately controlled so that a document of an A3 size can be accurately read and/or increased resolution scanning can be performed.

Moreover, while shown in the context of a non-moving document, it is understood that the document can be fed to the glass and/or move relative to the glass to increase a scanned area while reducing the movement of the scan module in other aspects of the invention.

While this invention has been particularly shown and described with reference to embodiments thereof, it will be understood by those skilled in the art that various changes in form and details may be made therein without departing from the spirit and scope of the invention as defined by the appended claims, and equivalents thereof.

What is claimed is:

1. An image reading apparatus comprising:
a scanning module to read an image of a document while sliding along an axis, the scanning module having a first end and a second end;
a guide module to guide the scanning module to slide along the axis; and
a drive module including a first timing belt coupled to the first end, a second timing belt coupled to the second end, a first belt pulley having teeth for circulating the first timing belt, a second belt pulley having teeth for circulating the second timing belt, a connection shaft coaxially connecting the first and second belt pulleys, a drive motor, and a gear train, as a driving force transfer member, directly connecting the drive motor and the first belt pulley.

2. The apparatus as claimed in claim 1, wherein the scanning module includes a sensor which slides with the scanning module, and the sensor comprises a contact image sensor (CIS) and/or a charge-coupled device (CCD) sensor.

3. The apparatus as claimed in claim 2, wherein the image reading apparatus has a capacity to read the document having an A3 size.

4. The apparatus as claimed in claim 3, further comprising a main body, wherein the drive module further comprises:
a first bracket coupling the first belt pulley, the drive motor, and the gear train to the main body; and
a second bracket coupling the second belt pulley to the main body.

5. The apparatus as claimed in claim 4, wherein each of the first and second brackets respectively comprise a stud inserted into the centers of the corresponding first and second belt pulleys and rotatably supporting the corresponding first and second belt pulleys.

6. The apparatus as claimed in claim 3, wherein the scanning module further comprises a guide hole, and the guide module comprises a guide shaft inserted into the guide hole so as to guide the scanning module along the axis.

7. The apparatus as claimed in claim 6, wherein a single guide shaft is clear to the first timing belt than to the second timing belt.

8. An image reading apparatus comprising:
a scanning module to read an image a document while sliding along an axis; and
a drive module including an axial transmission device coupled to the scanning module and having engaging elements, a positive transmission system directly engaged with the axial transmission device using the engaging elements to drive the scanning module along the axis, and a motor engaged with the positive transmission system to drive the positive transmission system to drive the scanning module along the axis.

9. The image reading apparatus of claim 8, wherein the positive transmission system and the engaging elements comprise male and female parts which interlock to directly drive the axial transmission device along the axis.

10. The image reading apparatus of claim 9, wherein the male and female parts comprise teeth which interlock to directly drive the axial transmission device along the axis.

11. The image reading apparatus of claim 8, wherein the axial transmission device comprises a pair of driving belts having corresponding teeth, and the positive transmission system includes corresponding gears with teeth that directly engage the teeth of the driving belts to drive the scanning module along the axis.
